(19) United States
(12) Patent Application Publication
(10) Pub. No.: US 2004/0154824 A1
(43) Pub. Date: Aug. 12, 2004

(54) Contact assembly for a rotatable circuit element

(75) Inventor: Hans Hesse, Paderborn (DE)

Correspondence Address: THE FIRM OF KARL F ROSS, 5676 RIVERDALE AVENUE, PO BOX 900, RIVERDALE (BRONX), NY, 10471-0900, US

(73) Assignee: HESSE & KNIPPS GmbH

(21) Appl. No.: 10/724,507

(22) Filed: Nov. 25, 2003

(30) Foreign Application Priority Data
Nov. 26, 2002 (DE) 10255277.0

(51) Int. Cl. H01B 7/08

(52) U.S. Cl. 174/117 F

(57) ABSTRACT

An assembly for electrically connecting a part rotatable about an axis with a relatively stationary part has an elongated multiconductor flat ribbon having a pair of ends and wound in a spiral around the axis. One of the ends is secured to the rotatable part and the other of the ends is secured to the stationary part. The flat ribbon is comprised of a flat elongated tape and a plurality of parallel conductive traces on the tape extending between the ends. The traces are flat strips with a width dimension parallel to the width dimension of the tape. The tape is nonconductive so that the traces are electrically isolated from one another.

### FIELD OF THE INVENTION

The present invention relates to a contact assembly for joining two relatively rotatable circuit elements. More particularly this invention concerns such a contact assembly used to connect up a rotatable head of an ultrasonic bonding machine.

### BACKGROUND OF THE INVENTION

In various applications, for instance in an ultrasonic wire-bonding apparatus, it is necessary to make a plurality of electrical connections between a rotating element, e.g. a bonding head, and a stationary element, e.g. the control circuit and power supply. It is essential, in particular when critical sensor data is being transmitted over the contact assembly, that the connection be perfectly continuous, ruling out use of a commutator-ring system. The connection problem is compounded when the movable part, in addition to pivoting about an axis, also moves axially and/or radially.

The standard system is to provide a relatively lengthy cable with flexible stranded-wire conductors. The cable is suspended such that no one part of it is subject to any significant flexing, so that in theory the individual elements are all deformed elastically, not plastically, and there is no actual fatigue. Such systems are not normally reliable in the long run, in particular as stress tends to concentrate at the ends of the cable where the connections are actually made. As a result metal fatigue sets in and the conductors break.

In another system proposed in German patent 196 01 599 of Hesse and Walther, the two relatively rotatable parts are joined by a plurality of conductors that are arrayed uniformly about the rotation axis and that each have one end attached to the rotatable part and an opposite end attached to the stationary part. The ends of each conductor are normally axially aligned and the conductors are substantially longer than the axial distance between their ends so that, when the parts are relatively rotated, each conductor assumes a helicoidal shape. Such a system is an improvement over the looped multiconductor cable arrangement, but the principle stress is still at the conductor ends, where failure due to fatigue is inevitable.

### OBJECTS OF THE INVENTION

It is therefore an object of the present invention to provide an improved electrical conductor assembly for connecting a rotatable part to a relatively stationary part.

Another object is the provision of such an improved electrical conductor assembly for connecting a rotatable part to a relatively stationary part which overcomes the above-given disadvantage, that is which has an extremely long service life.

### SUMMARY OF THE INVENTION

An assembly for electrically connecting a part rotatable or orbital about an axis with a relatively stationary part has according to the invention an elongated multiconductor flat ribbon having a pair of ends and wound in a spiral around the axis. One of the ends is secured to the moving part and the is other of the ends is secured to the stationary part.

Winding the conductor ribbon about itself in a multiturn spiral provides in effect a reservoir so that when the rotatable part turns about its axis, no one portion of the ribbon is stressed significantly more or less than any other portion. The spiral simply becomes somewhat tighter or looser, depending on rotation direction so that even a full rotation of 360°, for example, can readily be accommodated. With a large number of turns in the spiral, even larger rotations can be allowed without significant stress to the conductor cable.

According to the invention the one end is secured to the rotatable element inside the spiral and the other end is outside the spiral. The opposite orientation is also possible, with the part in the center of the spiral being stationary and the other part orbiting. around the axis.

The ribbon has a width dimension extending generally parallel to the axis. The term width is used here in the classic sense, that is, presuming the ribbon is lying in a plane, the ribbon's length dimension is its greatest dimension in the plane, its thickness is its smallest dimension and is perpendicular to the plane and to length dimension, and the width dimension is smaller than the length and greater than the width, and extends perpendicular to the other two dimensions but in the plane. Such a ribbon conductor is very stable and can be counted on to hold its shape in the spiral as the two parts relatively rotate.

The flat ribbon according to the invention is comprised of a flat elongated tape and a plurality of parallel conductive traces on the tape extending between the ends. The traces are flat strips with a width dimension parallel to the width dimension of the tape. The tape is nonconductive so that the traces are electrically isolated from one another.

A standard ribbon conductor can be made whose tape is made of polyimide (e.g. Kapton™) or polyester or PEN. Such a tape is stable to 250 ° C. even when it has a thickness of 12.5 μm. It is also possible to use a more exotic and temperature-resistant plastic, e.g. a liquid-crystal polymer, in certain applications.

The tape according to the invention is flexible-and the spiral is generally cylindrical and centered on the axis. Adjacent turns of the spiral are normally equispaced radially from each other, a radial spacing that changes as the two parts relatively rotate. Furthermore in accordance with the invention respective rigid circuit boards at the ends have contact pads connected to the traces. The ribbon is fastened flat to the boards, that is it is parallel to the boards at the ends, so that there is no flexing at the location where the ribbon is joined to the boards. Such a board can be 25 μm thick. The traces can be copper layers 4 μm to 35 μm thick with a 50 μm thick layer of glue holding them in place, for a total thickness of about 0.18 mm.

According to another feature of the invention, which permits limited relative axial movement of the two parts, the tape is L-shaped and has one leg forming the spiral and an other leg extending axially from the spiral. This other leg is formed with a loop projecting transversely of the axis.

The rotatable part according to the invention is a bonding head of an ultrasonic wire bonding device.

### BRIEF DESCRIPTION OF THE DRAWING

The above and other objects, features, and advantages will become more readily apparent from the following description, reference being made to the accompanying drawing in which:

FIG. 1 is an end view of a conductor assembly according to the invention;

FIG. 2 is a side view of the conductor assembly in flattened-out condition;

FIG. 3 is an end view of another conductor assembly in accordance with the invention;

FIG. 4 is a view taken in the direction of arrow IV of FIG. 3; and

FIG. 5 is a side view of the FIG. 3 conductor assembly in flattened-out condition.

### SPECIFIC DESCRIPTION

As seen in FIGS. 1 and 2, a contact assembly according to the invention serves for connecting a circuit element, e.g. a bonding head, shown schematically at 10 and rotatable about an axis 8 with a stationary circuit element, e.g. a control circuit and power supply, shown schematically at 11, although of course it would work identically if the part 10 were stationary and the part 11 orbited about it. The assembly basically comprises an elongated ribbon 1 comprising a polyimide-foil tape 2 carrying an array of parallel copper conductor traces 3. One end of the tape 2 is fixed to a rigid circuit board 4 having holes 6 allowing it to be secured to the rotatable element 10 and the opposite end is fixed to a similar circuit board 5 fixed to the stationary element 11. The boards 4 and 5 carry contact pads 7 that allow connections to be made to the conductors 3.

In use the tape 1 is wound around the end board 4 in a loose cylindrical spiral W centered on the axis 8. Thus as the part 10 rotates in one direction as indicated by arrow P1 about the axis 8 the spiral W will get tighter, and opposite rotation will make the spiral looser. Since at the ends the tape 1 is coplanar with the boards 4 and 6, there is no stress at the connection points, only slight flexing in an intermediate region. Because of the multiple turns of the spiral W, such flexing is well within the elastic limit of the tape 2 and conductors 3 so they can be counted on to remain intact for a long service life.

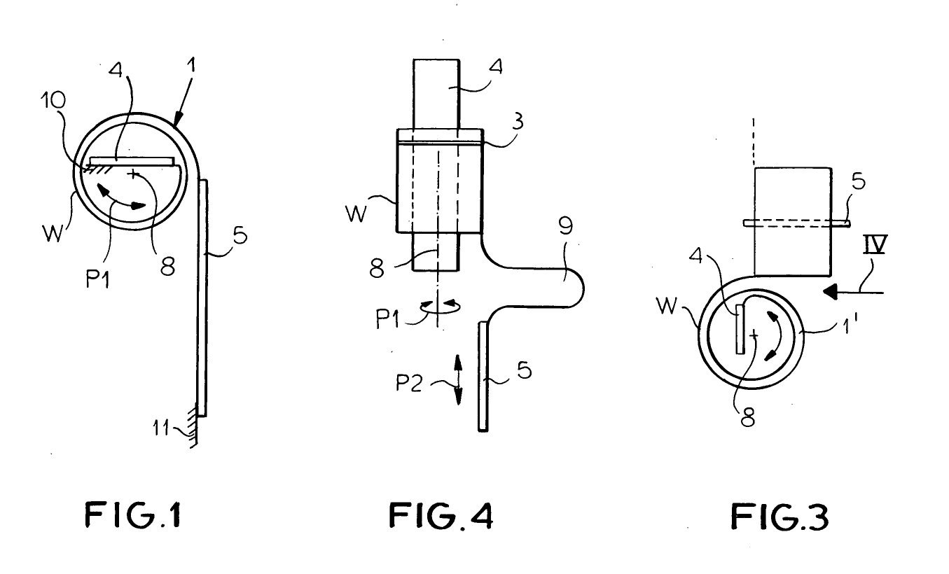

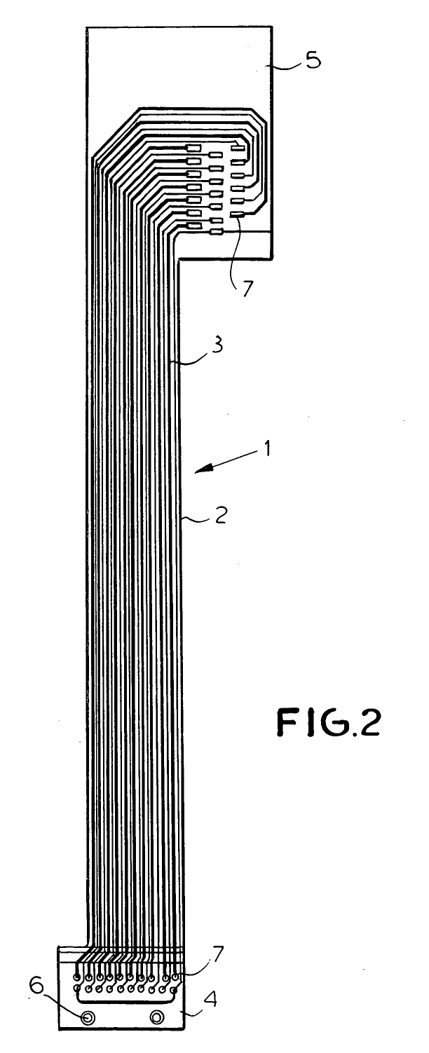

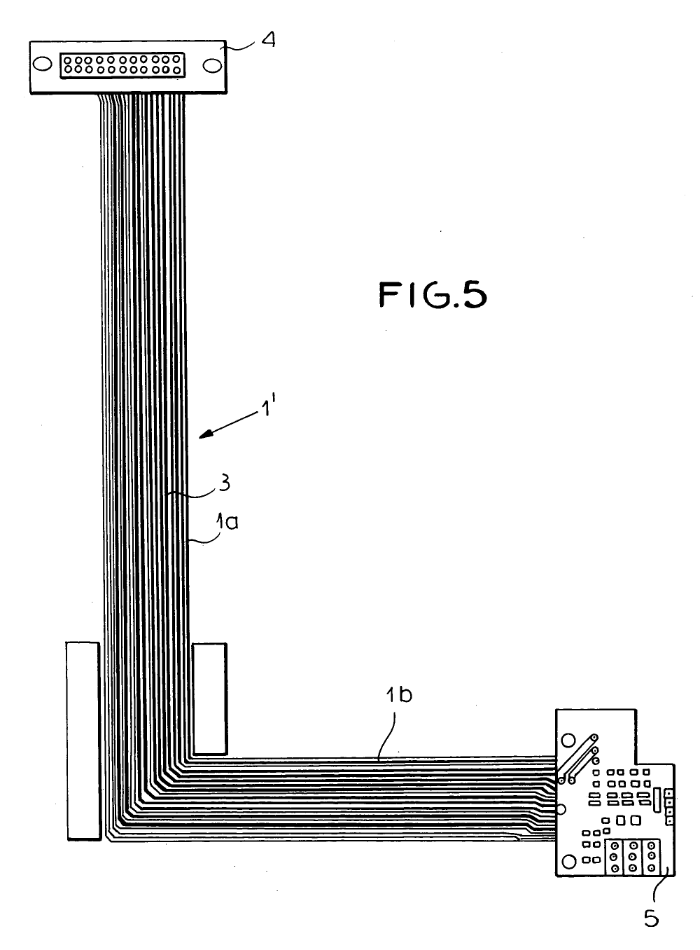

The system of FIGS. 3 to 5 is similar to that of FIGS. 1 and 2, but here the tape 1′ is L-shaped, having one leg la that is wound in the spiral W and another leg 1b that is formed into a loop 9 projecting transversely of the axis 8. Thus if the end 4 moves axially as shown by arrow P2, the loop 9 can open or close to allow this movement. Rotation about the axis 8 is of course permitted by the spiral W as in FIGS. 1 and 2.

I claim:

1. An assembly for electrically interconnecting two parts relatively rotatable about an axis, the assembly comprising:
an elongated multiconductor flat ribbon having a pair of ends and wound in a spiral centered on the axis, one of the ends being secured to one of the parts and the other of the ends being secured to the other part.

2. The electrical connecting assembly defined in claim 1 wherein the one end is secured to the one part inside the spiral and the other end is outside the spiral.

3. The electrical connecting assembly defined in claim 1 wherein the ribbon has a width dimension extending generally parallel to the axis.

4. The electrical connecting assembly defined in claim 3 wherein the flat ribbon is comprised of a flat elongated tape and a plurality of parallel conductive traces on the tape extending between the ends.

5. The electrical connecting assembly defined in claim 4 wherein the traces are flat strips with a width dimension parallel to the width dimension of the tape.

6. The electrical connecting assembly defined in claim 4 wherein the tape is nonconductive.

7. The electrical connecting assembly defined in claim 4 wherein the tape is flexible.

8. The electrical connecting assembly defined in claim 4 wherein the spiral is generally cylindrical and centered on the axis.

9. The electrical connecting assembly defined in claim 4, further comprising
respective rigid circuit boards at the ends having contact pads connected to the traces.

10. The electrical connecting assembly defined in claim 4 wherein the tape is L-shaped and has one leg forming the spiral and an other leg extending axially from the spiral.

11. The electrical connecting assembly defined in claim 10 wherein the other leg is formed with a loop projecting transversely of the axis.

12. The electrical connecting assembly defined in claim 1 wherein the one part is a bonding head.
